(19) United States
(12) Patent Application Publication
(10) Pub. No.: US 2001/0023552 A1
(43) Pub. Date: Sep. 27, 2001

(54) Termite controlling tablets

(76) Inventor: Izumi Fujimoto, Osaka (JP)

Correspondence Address: SUGHRUE, MION, ZINN, MACPEAK & SEAS, 2100 Pennsylvania Avenue, N.W., Washington, DC, 20037, US

(21) Appl. No.: 09/810,219

(22) Filed: Mar. 19, 2001

(30) Foreign Application Priority Data
Mar. 24, 2000 (JP) 2000-083955

(51) Int. Cl. A01M 1/20

(52) U.S. Cl. 43/132.1

(57) ABSTRACT

A termite controlling tablet, comprising at least one termite controlling active ingredient and at least one compressed paper shred, wherein said at least one termite controlling active ingredient is supported on the at least one compressed paper shred. Further, the present invention provides methods of controlling termites, said termite control methods comprising applying to a habitat of the termite, at least one of said termite controlling tablets. Furthermore, the present invention provides methods of producing termite controlling tablets, said production methods comprising compression treating at least one tangled paper shred having a width of 0.5 to 10 mm.

### FIELD OF THE INVENTION

The present invention relates to termite controlling tablets, methods of producing the termite controlling tablets and methods of controlling termites. Related Arts Japanese unexamined patent Hei9-322687 describes a termite controlling composition comprising a termite controlling active ingredient and a paper comprising cellulose. Japanese unexamined patent Hei9-322687 describes that the termite controlling composition thereof achieves an excellent termite controlling effect when set in a pathway within a termite nest. When set in the termite nest pathway, the termites tend to generally congregate at the location of where the termite controlling composition thereof is set. Such congregation in the termite nest pathway often present situations which necessitate applying a large amount of such a termite controlling composition thereof to achieve an effective termite control.

### SUMMARY OF THE INVENTION

The present invention provides termite controlling tablets, comprising at least one termite controlling active ingredient and at least one pressed paper shred, wherein the at least one termite controlling active ingredient is supported on the at least one pressed paper shred. Further, the present invention provides methods of controlling termites, said termite control methods comprising applying to a habitat of the termite, at least one of said termite controlling tablets. Furthermore, the present invention provides methods of producing termite controlling tablets, said production methods comprising compression treating at least one paper shred and adding a termite controlling active ingredient.

### BRIEF DESCRIPTION OF DRAWINGS

FIG. 1 depicts a termite controlling device in which one of the termite controlling compositions is stored in a container.

### DETAILED DESCRIPTION OF THE INVENTION

The present invention involves termite controlling tablets which can contain a large amount of a bait ingredient, such as paper. Typically, the termite controlling tablets are appropriate for a habitat of a termite.

A termite controlling tablet may be composed of at least one termite controlling active ingredient and at least one pressed paper shred, wherein said at least one termite controlling active ingredient is supported on the at least one pressed paper shred. Typically, the termite controlling tablets comprise the termite controlling active ingredient in an amount of from about 0.001 to 20% by weight or about 0.01 to 10% by weight, wherein said weight percentages are based on the total weight of the provided termite controlling tablet. But the amount of the termite controlling active ingredient in the termite controlling tablets may vary with the type of utilized termite controlling active ingredient therein.

As the termite controlling active ingredient utilized in the present invention, for example, there is mentioned carbamate compounds such as fenobucarb, xylylcarb, metolcarb, carbaryl, isoprocarb, propoxur and metoxadiazon; organophosphorus compounds such as chlorpyrifos, fenitrothion, malathion and phoxim; pyrethroid compounds such as tralomethrin, permethrin, cypermethrin, d-phenothrin, silafluofen, etofenprox, halfenprox, bifenthrin, acrinathrine, transfluthrin, cyphenothrin, fenvalerate, prallethrin and imiprothrin; arylpyrrole compounds or arylpyrazole compounds such as chlorfenapyr; nitroguanidine compounds or cyanoguanidine compounds such as acetamiprid, nitenpyram, thiamethoxam, thiacloprid and dinotefuran; macrolide compounds such as ivermectin, avermectin, emamectin, nemadectin and spinosad; insect growth regulators such as diflubenzuron, chlorfluazuron, hexaflumuron, lufenuron, lufenuron, flufenoxuron, diafenthiuron, novaluron, fluazuron, teflubenzuron, triflumuron, cyromazine, dicyclanil, buprofezin, etoxazole, pyridaben, pyriproxyfen, tebufenozide, methoxyfenozide, halofenozide, fenoxycarb, diofenolan, methoprene and hydroprene; phenylpyrazole compounds; natural microorganisms such as Beauveria, Metarhizium; and the like as well as mixtures thereof. When utilizing a termite controlling active ingredient also having a repellency directed to the termites, it is preferable that the termite controlling tablets utilize a microencapsulated form of the termite controlling active ingredient. Further, it is worth noting that the termite controlling tablets may utilize microencapsulated forms of termite controlling active ingredients substantially lacking the repellency directed to the termites.

In the termite controlling tablets, there can also be utilized with the termite controlling active ingredient, synergists such as piperonyl butoxide (PBO), octachlorodipropyl ether (S421), N-(2-ethylhexyl)-bicyclo[2.2.1.]-hept-5-ene-2,3-dicarboximide; sterol derivatives; attractants such as (3Z,6Z,8E)-dodecatrienol; and the like.

The termite controlling tablets can be produced by adding the termite controlling active ingredient to at least one tangled or crumpled paper shred and compression treating the at least one tangled or crumpled paper shred. Typically, a plurality of the paper shreds is utilized in the termite controlling tablets. For example, to provide at least one tangled or crumpled paper shred, a sheet of paper can be shredded with a conventional documents shredder to the width of, for example, about 0.5 to 10 mm or about 0.5 to 3 mm. In such cases, the sheet of paper can be shredded and the at least one paper shred can be tangled simultaneously. A compressor conventionally utilized to produce well-known pesticidal or pharmaceutical tablet formulations can be utilized to compression treat the at least one paper shred to a tablet. When adding the termite controlling active ingredient, the termite controlling active ingredient can be added to the at least one tangled or crumpled paper shred before or after compression treating the at least one tangled or crumpled paper shred. For example, the termite controlling active ingredient can be added to the sheet of paper, such that the sheet of paper is then shredded and compression treated to produce the termite controlling tablet. The compressed paper shred or shreds may be produced by compression treating the at least one paper shred at a pressure of about 1 to 10000 kg/cm². In such cases, the compressed paper shred or shreds may be compressed to a volume of from about 1 to 20000 cm³. The termite controlling active ingredient may be added to the crumpled or tangled paper shred or the sheet of paper by dripping, soaking or spreading the termite controlling active ingredient thereto. In such cases, the termite controlling active ingredient may optionally be dissolved or dispersed in an organic solvent before being added to the crumpled or tangled paper shred or sheet of paper.

In the present invention, the compression treatment is usually conducted after the at least one paper shred has been tangled or crumpled. For example, after utilizing a conventional paper shredder, the at least one tangled or crumpled paper shred can be gathered together into a quasi-tablet form and then compression treated so that the resulting tablet has a weight of about 0.1 to 1000 g or about 0.1 to 1000 g or about 10 to 200 g. Further, in the compression treatment, the at least one paper shred may be formed into various shapes such as a cylinder, polyhedron (e.g. a quadrahedron and pentahedron), sphere and the like.

Further, to better preserve the shape of the termite controlling tablet, there can be utilized with the at least one paper shred, before or after the compression treatment, an adhesive, packaging wrap or the like. Preferably, the adhesive also has the properties to attract or stimulate the appetite of termites, such as cornstarch, sweet potato starch and the like. Examples of the packaging wrap include a meshed sack, shrink film, unwoven cloth, cardboard and the like. For example, the termite controlling tablets may be produced by inserting after adding the termite controlling active ingredient, the at least one tangled paper shred into the mesh sack and then conducting the compression treatment. When utilized, the mesh sack usually has the mesh size thereof large enough so that a termite can pass through. When utilizing the shrink film, the shrink film is usually utilized such that, in the resulting termite controlling tablets, the shrink film has at least one hole large enough have a termite to pass through. Further, holes may be added to the resulting termite controlling tablets after being wrapped with the shrink film. The cardboard may also act as an attractant or stimulant when utilized in the termite controlling tablets.

As the paper utilized to produce the paper shred, for example, there is mentioned a cellulose paper, paper comprising starch, paper comprising CMC, inorganic fiber paper, paper comprising water absorbent polymer and the like. The cellulose paper may be a conventional paper comprising a cellulose ingredient. In the cellulose paper, the cellulose may be in the form of various vegetal fibers such as that of needle leaf trees or broad leaf trees, bagasse, hemp, paper mulberry and the like. The cellulose paper may also contain a mixture of the vegetal fibers.

As the termites controlled in the present invention, for example, there is mentioned Mastotermitidae, Termopsidae (Zootermopsis, Archotermopsis, Hodotermopsis, Porotetermes and Stolotermes), Kalotermidae (Kalotemes, Neotermes, Cryptotermes, Incisitermes and Glyptotermes), Hodotermitidae (Hodotermes, Microhodotermes and Anacanthotermes), Rhinotermitidae (Reticulitennes, Heterotermes, Coptotermes and Schedolinotermes), Serritermitidae, Termitidae (Amitermes, Drepanotermes, Hopitalitermes, Trinervitermes, Macrotermes, Nasutitermes, Percapritermes and Anoplotermes) and the like.

Further, as specific examples of termites subject to control in the present pacific territory, there is mentioned Reticulitermes speratus, Coptotermes formosanus, Incisitermes minor, Cryptotermes domesticus, Odontotermes formosanus, Neotermes koshunensis, Glyptotermes satsumensis, Glyptotermes nakajimai, Glyptotermes fuscus, Glyptotermes kodamai, Glyptotermes kushimensis, Hodotermopsis japonica, Coptotermes guangzhoensis, Reticulitermes mivatakei, Reticulitermes flaviceps amamianus, Reticulitermes sp., Nasutitermes takasagoensis, Pericapriterme nitobei, Sinocapritermes mushae and the like.

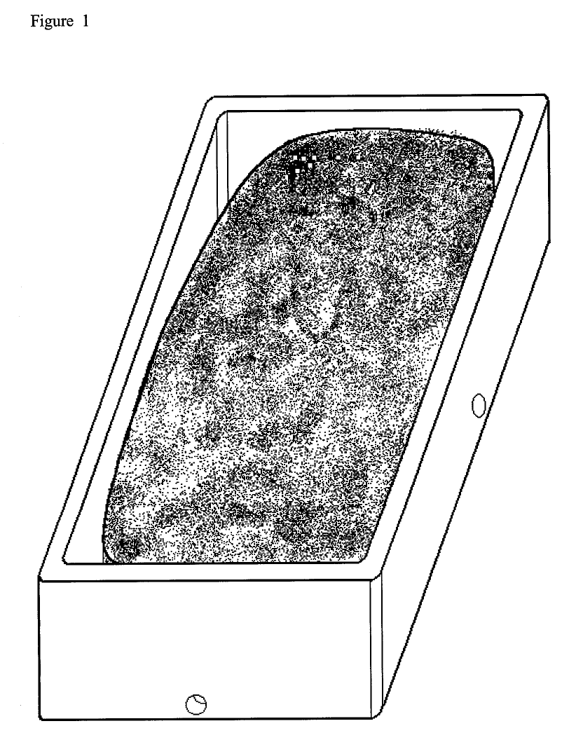

When utilizing the termite controlling tablets, the termite controlling tablets may be applied as is, but may also be utilized in a termite controlling device. The termite controlling device may have at least one of the termite controlling tablets stored in a container. Typically, the container has at least one hole so that a termite can pass through, such as about 1 to 100 pierced holes. Such a hole in the container, so that a termite can pass through, may have an area of from about 0.002 to 3.2 cm². For example, as depicted in FIG. 1, there can be utilized a termite controlling device in which the termite controlling tablet is stored in a pipe-form container having a plurality of pierced holes at the lower portion of the side walls thereof. To produce the container, there may be utilized metals, resins, lumbers and the like. Further, the volume and shape of the container is not particularly limited. The container may also have a cover.

To control termites, the termite controlling tablets can be applied to a habitat of the termite, whether or not there is a termite present at the time of application. For example, at least one of the termite controlling tablets may be placed or set in an area involving wood or soil, which area involving wood or soil may include areas such as a termite nest pathway, the soil underneath a building floor or the like. By “building”, it means an edifice structure which can hold at least one human person. In this regard, examples of such buildings include offices, houses, apartments, cabins, huts and the like.

The application amount of the termite controlling tablets varies with the type of termite controlling active ingredient therein and may, for example, be an amount such that the termite controlling active ingredient is in an amount of from about 0.001 to 200 g. A well infested house may have termites controlled by applying the termite controlling tablets at 1 to 5 areas thereof.

### EXAMPLES

Next, production examples and test examples are mentioned to more specifically describe the present invention.

### Production Example 1

One-half (0.5) grams of etoxazole were dissolved in 270 ml of acetone. The resulting acetone solution was spread on 3 sheets of paper comprising paper mulberry. The paper had the dimensions of 64×94 cm and had a total weight of 100 g. After drying, the paper was shredded and tangled with a shredder, such that the width of the paper shreds were 2 to 3 mm. The paper shreds were gathered into a quasi-tablet and the quasi-tablet was compression treated at 100 kg/cm² of pressure. A quadrahedral termite controlling tablet (length 10 cm×width 10 cm×height 5 cm) was obtained.

### Production Example 2

An one-thousandth (0.001) gram of chlorfenapyr was dissolved in 3 ml of acetone. The resulting acetone solution was spread onto paper comprising 1 g of CMC. After drying, the paper was shredded and tangled with a shredder, such that the width of the paper shreds were 2 to 3 mm. The paper shreds were gathered into a quasi-tablet and the quasi-tablet was compression treated at 100 kg/cm² of pressure. A cylindrical termite controlling tablet (diameter: about 3 cm, height: 2 to 3 cm) was obtained.

### Production Example 3

Five-thousandths (0.005) grams of acetamiprid were dissolved in 3 ml of acetone. The resulting acetone solution was spread onto paper comprising 1 g of CMC. After drying, the paper was shredded and tangled with a shredder, such that the width of the paper shreds were 2 to 3 mm. The paper shreds were gathered into a quasi-tablet and the quasi-tablet was compression treated at 100 kg/cm² of pressure. A cylindrical termite controlling tablet (diameter: about 3 cm, height: 2 to 3 cm) was obtained.

### Production Example 4

Five-thousandths (0.005) grams of thiamethoxam were dissolved in 3 ml of acetone. The resulting acetone solution was spread onto paper comprising 1 g of CMC. After drying, the paper was shredded and tangled with a shredder, such that the width of the paper shreds were 2 to 3 mm. The paper shreds were gathered into a quasi-tablet and the quasi-tablet was compression treated at 100 kg/cm² of pressure. A cylindrical termite controlling tablet (diameter: about 3 cm, height: 2 to 3 cm) was obtained.

### Production Example 5

An one-thousandth (0.001) gram of chlorfenapyr was dissolved in 10 ml of acetone. The resulting acetone solution was fully spread onto a cardboard of 3 cm×3 cm×1.5 cm (Tohnoh Core Company, honeycore S120, weight of 1 g). After drying, the cardboard was shredded and tangled. The resulting paper shreds were gathered into a quasi-tablet and the quasi-tablet was compression treated at 100 kg/cm² of pressure. A cylindrical termite controlling tablet (diameter: about 3 cm, height: 2 to 3 cm) was obtained.

### Test Example 1

The termite controlling tablet produced in Production Example 2 was placed into a white plastic container in which 1 hole on the bottom surface and 4 holes (diameter of 3 mm) were on the side walls, such that termites can pass through the holes. The resulting termite controlling device was applied to an appropriate area and 50 worker termites were then released into the area. The vitality of the termites was observed after a month. As a result, all of the termites died.

### Test Example 2

The termite controlling tablet produced in Production Example 3 was placed into a white plastic container in which 1 hole on the bottom surface and 4 holes (diameter of 3 mm) were on the side walls, such that termites can pass through the holes. The resulting termite controlling device was applied to an appropriate area and 50 worker termites were then released into the area. The vitality of the termites was observed after a month. As a result, all of the termites died.

### Test Example 3

The termite controlling tablet produced in Production Example 4 was placed into a white plastic container in which 1 hole on the bottom surface and 4 holes (diameter of 3 mm) were on the side walls, such that termites can pass through the holes. The resulting termite controlling device was applied to an appropriate area and 50 worker termites were then released into the area. The vitality of the termites was observed after a month. As a result, all of the termites died.

What is claimed is:

1. A termite controlling tablet, comprising at least one termite controlling active ingredient and at least one compressed paper shred, wherein said at least one termite controlling active ingredient is supported on the at least one compressed paper shred.

2. A termite controlling device, comprising:
at least one termite controlling tablet of claim 1 and
a container having at least one pierced hole which termites can pass through,
wherein said at least one termite controlling tablet is stored in said container.

3. A method of controlling termites, said method comprising:
applying to a habitat of the termite, a termite controlling tablet of claim 1.

4. The method according to claim 3, comprising applying over the ground under a floor, the termite controlling tablet.

5. The method according to claim 3, comprising applying at a termite infested area, the termite controlling tablet.

6. The method according to claim 3, comprising applying to the habitat of the termite, the termite controlling device of claim 2.

7. A method of producing a termite controlling tablet, comprising:
compression treating at least one paper shred and adding at least one termite controlling active ingredient to at least one paper shred.

8. The method according to claim 7, comprising:
compression treating at least one crumpled or tangled paper shred and
adding at least one termite controlling active ingredient to the at least one crumpled or tangled paper shred.
